(19) United States
(12) Patent Application Publication
(10) Pub. No.: US 2025/0001865 A1
(43) Pub. Date: Jan. 2, 2025

(54) DISPLAY METHOD

(71) Applicant: Faurecia Clarion Electronics Europe, Paris (FR)

(72) Inventors: Sébastien MEYER, Paris (FR); Vanessa PICRON, Paris (FR)

(21) Appl. No.: 18/757,473

(22) Filed: Jun. 27, 2024

(30) Foreign Application Priority Data
Jun. 28, 2023 (FR) 2306793

(51) Int. Cl. B60K 35/29; B60K 35/22; B60K 35/28

(52) U.S. Cl. CPC B60K 35/29; B60K 35/22; B60K 35/28; B60K 2360/119; B60K 2360/176; B60K 2360/177; B60K 2360/179; B60K 2360/1868; B60K 2360/21; B60K 2360/779; B60K 2360/797

(57) ABSTRACT

An image display method includes the following steps: capturing images via an imager; detecting whether at least one obstacle is present via a telemetry device and, if the at least one obstacle is present, receiving distance data between the detected obstacle and the vehicle; determining whether the quality of visibility outside the vehicle is below a defined threshold; and determining whether predefined conditions representative of a hazard for the vehicle are met. The predefined conditions include at least the received distance data. The method includes, if the predefined conditions representative of a hazard are met and if the visibility quality is below the defined threshold, displaying the captured images on an area of the display screen and superimposing, on these captured images, in real time, at least one synthesis image to signal the detected obstacle.

### TECHNICAL FIELD

The present invention relates to the field of image processing and display methods for images captured by cameras arranged on a motor vehicle.

### BACKGROUND

It is known to display images with augmented reality features to assist the driver in driving a vehicle. Augmented reality is the superposition of reality and features calculated by a computer system in real time. However, these augmented reality features increase the driver's cognitive load and can have a counterproductive effect.

### SUMMARY

A first aim of the present invention is to provide the driver with a driving aid by displaying augmented reality features, but without increasing his cognitive load.

A second aim of the present invention is to identify situations likely to represent a hazard for the vehicle from data measured by measuring devices, and to display augmented reality features only when a situation likely to represent a hazard has been identified.

A third aim of the present invention is to reduce the energy consumption of the display system.

A fourth aim of the present invention is to increase driving safety.

For these and other objects of the present invention, there is provided a method of displaying images on a display screen of a motor vehicle, said method being implemented by a display system comprising at least one first imager suitable for capturing images outside the vehicle, at least one telemetry device for detecting obstacles, a processing unit connected to said at least one first imager and to said at least one telemetry device, and a display screen connected to the processing unit, the display method comprising the following steps:
capturing images via said first imager,
detecting whether at least one obstacle is present via said telemetry device and, if said at least one obstacle is present, receiving distance data between said at least one detected obstacle and the vehicle,
determining whether the quality of visibility outside the vehicle is below a defined threshold,
determining whether predefined conditions representative of a hazard for the vehicle are met, the hazard originating from said at least one detected obstacle, said predefined conditions comprising at least the received distance data,
if the predefined conditions representative of a hazard are met and if the visibility quality is below the defined threshold, displaying the captured images on an area of the display screen and superimposing, on these captured images and around said at least one detected obstacle, in real time, at least one synthesis image to signal said at least one detected obstacle.

The display method only displays an augmented reality feature for the detected obstacle when there is a potential collision hazard. This method reduces the cognitive load on the driver and reduces the energy consumption of the display system. What is more, drivers are more receptive to a hazard warning feature when they have not become accustomed to constantly viewing augmented reality features. This display method is therefore more user-friendly.

The following features disclosed may optionally be implemented. They can be implemented independently of one another or in combination with one another:
if the predefined conditions representative of a hazard are not met, or if the visibility quality is equal to or greater than the defined threshold, the method comprises a step of displaying the images captured by the first imager on said area of the display screen.
if the predefined conditions representative of a hazard are not met and if the visibility quality is less than said defined threshold, the method comprises a step of displaying the images captured by said first imager on said area of the display screen.
the display system further comprises a second imager installed inside the vehicle and adapted to capture images representing the driver of the vehicle, and further comprises the following steps:
capturing images via said second imager,
determining the position of the vehicle driver's gaze from images captured via the second imager,
at least partially reducing a brightness of said area of the display screen when the determined gaze position is not directed toward said area of the display screen and when the predefined conditions representative of a hazard are not met.
the method comprises a step of generating said at least one synthesis image comprising at least one signaling feature suitable for signaling the presence of the obstacle, the signaling feature being one of an arrow, an icon, a geometric figure, an overlay of said obstacle and an outline of said obstacle.

The method further comprises a step of identifying said obstacle from the distance data, and wherein the generating step comprises generating a signaling feature representative of the identified obstacle.

The step of determining whether the predefined conditions have been met comprises the following steps:
calculating the distance between said obstacle and the vehicle from the distance data, comparing the calculated distance with a first defined distance value.
the processing unit is adapted to receive at least one datum representative of the temperature outside the vehicle and at least one datum representative of the humidity outside the vehicle, and wherein the step of determining whether the predefined conditions have been met comprises the following steps:
calculating the distance between said obstacle and the vehicle from the distance data,
receiving at least one temperature datum and/or at least one humidity datum,
comparing said temperature datum with at least one threshold temperature, and/or
comparing said humidity datum with at least one threshold humidity,
if said temperature datum is lower than said threshold temperature and/or if said humidity datum is lower than said threshold humidity, comparing said calculated distance with a second defined distance value.

The step of determining whether the predefined conditions have been met comprises the following steps:
calculating an amplitude and/or orientation of the speed of said obstacle,—comparing the calculated amplitude with a defined amplitude and/or comparing the calculated orientation with a defined orientation range.

The step of determining the quality of visibility outside the vehicle is carried out based on images captured by the first imager and/or distance data received.

The method further comprises a step for comparing the brightness level of the images captured by the first imager with a defined threshold brightness.

The method comprises a step of determining the position of said obstacle from the distance data, and generating synthesis images wherein the signaling feature is moved simultaneously with the movement of the obstacle.

The at least one telemetry device comprises a radar, lidar or infrared light device.

### BRIEF DESCRIPTION OF THE DRAWINGS

FIG. 1 is a perspective view of a vehicle interior showing part of the display system implementing the display method according to an embodiment of the invention;

FIG. 2 is a schematic view of the display system implementing the display method;

FIG. 3 is a flowchart showing the steps of the display method;

FIG. 4 is a flowchart showing a first example of a method for determining that predefined conditions representative of a hazard have been met;

FIG. 5 is a flowchart showing a second example of a method for determining that predefined conditions representative of a hazard have been met;

FIG. 6 is a flowchart showing a third example of a method for determining that predefined conditions representative of a hazard have been met;

FIG. 7 is a schematic view of a first image captured by the first imager;

FIG. 8 is a schematic view of the first image and a synthesis image superimposed on this first image;

FIG. 9 is a schematic view of a second image captured by the first imager and of a synthesis image superimposed on this second image; and

FIG. 10 is a flowchart showing the display method steps implemented when the display system comprises a second imager.

### DETAILED DESCRIPTION

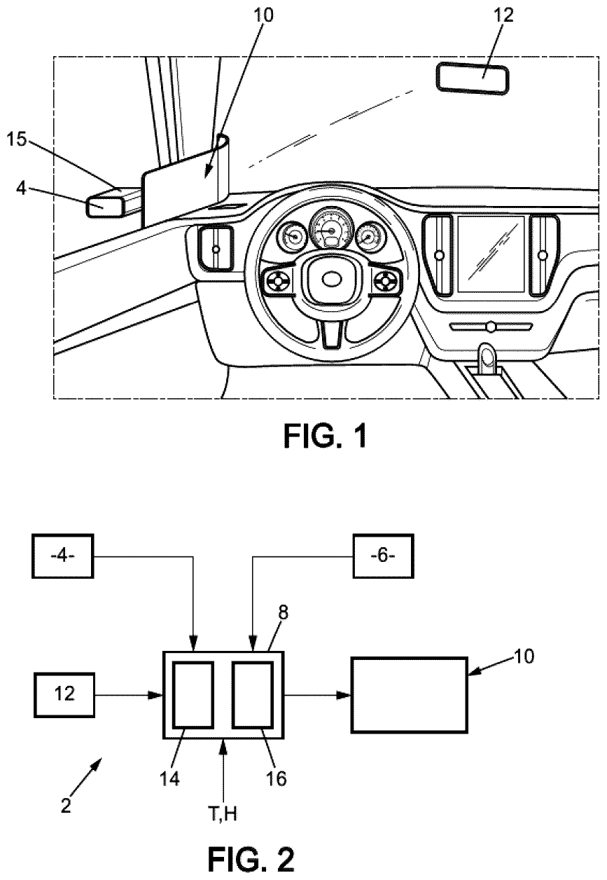

With reference to FIGS. 1 and 2, the display system 2 implementing the display method according to an embodiment of the invention comprises a first imager 4 suitable for capturing images outside the vehicle, a telemetry device 6 suitable for detecting the presence of an obstacle, a processing unit 8 connected to the first imager and to the telemetry device 6, and a display screen 10 connected to the processing unit 8.

The first imager 4 may be a camera. The first imager is, for example, arranged in the exterior rearview mirror, for example, on the driver's side. It has a first field of view extending along the side of the vehicle and toward the rear of the vehicle.

The telemetry device 6 comprises a radar, for example. This radar has a second field of view comprising at least part of the first field of view. It is located at the rear of the vehicle. It is able to detect the presence of an obstacle 7 located around the vehicle and in particular to the side and rear of the vehicle. It is configured to receive distance data representative of the distance between the telemetry device and the obstacle 7.

In this patent application, the term “obstacle” refers to any object, person or animal, whether mobile or stationary, located in the second field of view, which could potentially obstruct the vehicle. An obstacle can, for example, be a pedestrian, a truck, a car, a bicycle, a motorcycle, a scout, a tractor, a flock of sheep, an animal, etc. A bicycle-type obstacle is shown in FIG. 9.

Alternatively, the telemetry device 6 can also be fitted in the exterior rear view mirror 15.

Alternatively, the telemetry device can be a lidar or an infrared light device, in particular a time-of-flight (ToF) sensor.

Preferably, the display system 2 comprises several telemetry devices 6.

The processing unit 8 comprises a memory 14, in particular a flash memory, and a central processing unit 16 such as a processor or microprocessor. The central processing unit 16 can be a programmable device using software, an application-specific integrated circuit (ASIC) or part of an electronic control unit (ECU).

The memory 14 stores executable image processing code, hereinafter referred to as “image processing application,” and executable code for implementing the display method disclosed below.

The memory 14 also stores a defined threshold S, a defined threshold brightness Ls, a defined first distance value D1, a threshold temperature Ts, a threshold humidity Hs, a defined second distance value D2, a defined amplitude As and a defined orientation range Ps.

In the embodiment shown, the display screen 10 is mounted on the A-pillar. Alternatively, it can be mounted on the front door of the vehicle, or in the door, or on the center console.

In a first embodiment, captured images and, if required, the synthesis images are displayed over the entire screen. In a second embodiment, the display screen can be divided into several areas. Each area can display different images. One of the areas displays captured images and, where applicable, the synthesis images.

The connection links between the first imager 4 and the processing unit 8, the telemetry device 6 and the processing unit 8, the display screen 10 and the processing unit 8 can be wired or wireless.

In a particular embodiment, the display system 2 further comprises a second imager 12 connected to the processing unit. The second imager 12 is designed to capture images of the vehicle driver and transmit them to the processing unit 8.

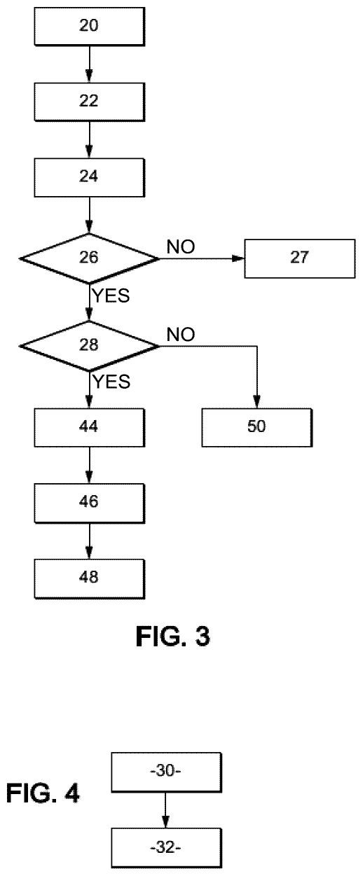

With reference to FIG. 3, the display method begins with a step 20 wherein the first imager 4 captures images 16 on the outside of the vehicle, and in particular, on the side and rear of the vehicle. The first imager 4 transmits the captured images 16 to the processing unit 8. An example of a captured image 16 is shown in FIG. 7.

Then, in a step 22, the telemetry device 6 detects whether an obstacle 7 is present in the second field of view.

When the telemetry device 6 detects an obstacle 7, it receives, in a step 24, data representative of the distance between the telemetry device 6 and the obstacle 7, hereinafter referred to as distance data. It transmits this distance data to the processing unit.

In a step 26, the processing unit determines whether a quality of visibility outside the vehicle is below a defined threshold S. This step can be carried out by various methods, implemented individually or in combination.

According to a first method, step 26 of determining the quality of visibility outside the vehicle is carried out based on captured images 16, and distance data received.

The image processing application searches for the presence of an obstacle 7 by processing the captured images 16, for example using a contour detection method. At the same time, the processing unit 8 checks whether the telemetry device 6 has detected an obstacle 7. If the telemetry device 6 has detected an obstacle 7 and the image processing application detects no obstacle, then the processing unit 8 determines that the quality of visibility outside the vehicle is below the defined threshold S.

In a second method, the image processing application determines the brightness level of at least some of the images captured by the first imager and compares this brightness level with a defined threshold brightness Ls. If the brightness level is below the defined threshold brightness Ls, then the processing unit 8 determines that the visibility quality outside the vehicle is below the defined threshold S. This method detects whether the vehicle is in a low-visibility environment.

In a third method, a vehicle brightness sensor determines the brightness outside the vehicle, and the processing unit determines whether the brightness is below a given threshold.

If the processing unit determines that the quality of visibility outside the vehicle is equal to or greater than the defined threshold S, or if the processing unit determines that the predefined conditions representative of a hazard are not met, at least one area of the display screen displays the images captured during a step 27. In particular, at least one area of the display screen displays only the captured images. The processing unit 8 does not superimpose a synthesis image 18 on the captured images 16.

If the processing unit determines that the visibility quality outside the vehicle is below the defined threshold S, the method continues with step 28. During this step 28, the processing unit 8 determines whether the detected obstacle 7 meets predefined conditions representative of a hazard for the vehicle. This stage can be carried out by different methods, implemented individually or in combination.

According to a first method shown in FIG. 4, the determination step 28 comprises a sub-step 30 for calculating the distance between the detected obstacle 7 and the telemetry device 6 from the distance data, and a sub-step 32 for comparing the calculated distance with a first defined distance value D1. The first defined distance value D1 has already been stored in memory 14. The first defined distance value D1 is equal to or greater than a predefined safety distance to be respected.

If the calculated distance is less than the first defined distance value D1, the processing unit determines that the detected obstacle 7 meets or fulfills the predefined conditions representative of a hazard for the vehicle.

Thus, when step 28 is performed according to the first method, the predefined conditions comprise the fact that the distance calculated during sub-step 30 is less than the first defined distance value D1.

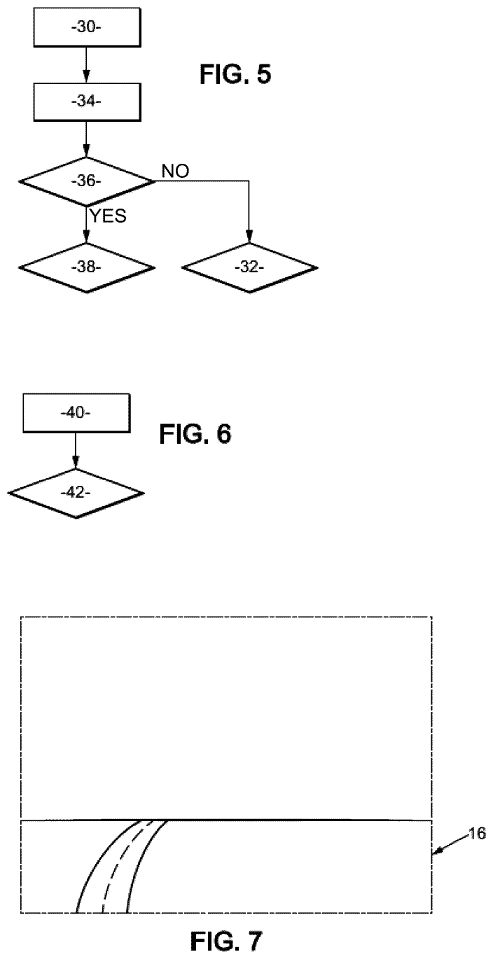

According to a second method shown in FIG. 5, the processing unit 8 calculates the distance between the detected obstacle 7 and the telemetry device 6 from the distance data in sub-step 30.

Then, in a sub-step 34, the processing unit 8 receives at least one datum T representative of the temperature outside the vehicle and/or at least one datum H representative of the humidity outside the vehicle. This data is measured, for example, by a temperature sensor and a humidity sensor mounted on the vehicle and connected to the processing unit.

Then, in a sub-step 36, the processing unit 8 compares the temperature data T with a threshold temperature Ts, and/or compares the humidity data H with a threshold humidity Hs.

If the temperature data T is lower than the threshold temperature Ts, and/or if the humidity data H is lower than the threshold humidity Hs, the processing unit 8 compares the calculated distance with a second defined distance value D2 in a sub-step 38. This second distance value D2 corresponds to the safety distance in the event of rain or fog.

If the temperature datum T is lower than the threshold temperature Ts, and/or if the humidity datum H is lower than the threshold humidity Hs and if the calculated distance is lower than the second defined distance value D1, the processing unit determines that the detected obstacle 7 meets predefined conditions representative of a hazard for the vehicle.

If the temperature datum T is not lower than the threshold temperature Ts and/or the humidity datum H is not lower than a threshold humidity Hs, the processing unit compares the calculated distance with the first defined distance value D1 in a step 32.

Thus, when step 28 is performed according to the second method, the predefined conditions comprise a calculated distance below the second defined distance value D2 and a temperature below the threshold temperature Ts and/or a humidity below the threshold humidity Hs.

According to a third method shown in FIG. 6, in a sub-step 40, the processing unit 8 calculates an amplitude and/or orientation of the obstacle 7 speed. This amplitude and/or orientation can be calculated from several distance data measured over a predefined period of time.

In a sub-step 42, the processing unit 8 compares the velocity amplitude of the obstacle 7 with a defined amplitude As. In the same way, the processing unit 8 checks whether the orientation of the movement of the obstacle 7 is within a defined orientation range Ps relative to the vehicle. If the calculated velocity amplitude is greater than the defined amplitude As and/or if the calculated orientation is within a defined orientation range Ps relative to the vehicle, the processing unit determines that the detected obstacle 7 meets predefined conditions representative of a hazard for the vehicle. Advantageously, this sub-step 42 can be used to anticipate a lane change, overtaking or acceleration of an obstacle such as a car, motorcycle or bicycle.

When step 28 is performed according to the third method, the predefined conditions comprise that the velocity amplitude of the detected obstacle is greater than a defined amplitude As and/or that the orientation of the detected obstacle's movement is within a defined orientation range Ps.

Alternatively or additionally, the predefined conditions can also comprise the brightness level outside the vehicle. When this brightness level is below a brightness threshold, the driver is considered to have a reaction time greater than the reaction time for daytime driving, and the braking distance is therefore increased, so the defined distance value is also increased.

If visibility is below the defined threshold S and if the predefined conditions representative of a hazard are met, the method continues with a step 44 wherein the processing unit 8 identifies the obstacle using distance data and possibly images captured by the first imager 4. Obstacle identification consists in identifying whether the obstacle is a pedestrian, a truck, a car, a bicycle, a motorcycle, a scout, a tractor, a flock of sheep, an animal, etc.

Step 44 is optional.

In a step 46, the processing unit 8 determines the position of the obstacle from the distance data and generates synthesis images 18.

Synthesis images 18 depict at least one signaling feature 19 designed to indicate the presence of the obstacle. The signaling feature 19 is, for example, an arrow, an icon or a geometric figure such as a square or a circle.

The synthesis images are generated in real time from the continuously received distance data, so that in the synthesis images the signaling feature 19 is moved simultaneously with the movement of the obstacle located outside the vehicle.

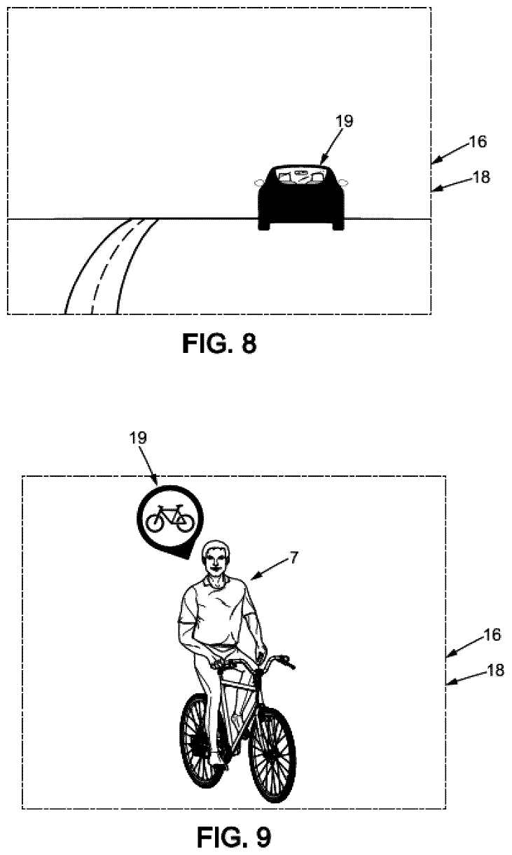

When the method comprises a step 44, the signaling feature 19 represents the identified obstacle. In this way, signaling feature 19 can be an icon representative of the identified obstacle or an overlay representative of the identified obstacle or an outline of the obstacle. Thus, an icon representing a bicycle has been generated on synthesis image 18, which is superimposed on a captured image 16, in the example shown in FIG. 9. An overlay of a vehicle positioned where the vehicle has been identified has been generated on the synthesis image 18, which is superimposed on a captured image 16 in the example shown in FIG. 8. An overlay is the printing of two or more images on the same sensitive surface. In this case, the sensitive surface is an area of the display screen.

When the method does not comprise a step 44 to identify the obstacle, the processing unit 8 generates synthesis images comprising an icon or arrow showing the location of the obstacle without depicting its identification.

In a step 48, the processing unit 8 displays the images captured by the first imager 4 on the display screen 10 and superimposes, in real time, the synthesis images 18 on the captured images to signal the presence and position of the obstacle 7.

If, after step 28, the detected obstacle 7 does not meet the predefined conditions representative of a hazard, the method continues with step 50. In step 50, at least one area of the display screen displays the captured images. In particular, at least one area of the display screen displays only the captured images. The processing unit 8 does not superimpose a synthesis image 18 on the captured images 16.

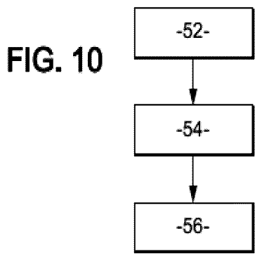

In the embodiment where the display system 2 further comprises a second imager 12 capable of capturing images depicting the vehicle driver, the display method can comprise, with reference to FIG. 10, a step 52 of capturing images via said second imager 12.

Then, in a step 54, the processing unit 8 determines the position of the vehicle driver's gaze from the images captured by the second imager.

In a step 56, the brightness of the display screen 10 is at least partially reduced when the determined position corresponds to the driver looking away from the display screen.

1. A method of displaying images on a display screen of a motor vehicle, said method being implemented by a display system comprising at least one first imager suitable for capturing images outside the vehicle, at least one telemetry device for detecting obstacles, a processing unit connected to said at least one first imager and to said at least one telemetry device, and a display screen connected to the processing unit, the display method comprising the following steps:
capturing images via said first imager,
detecting whether at least one obstacle is present via said telemetry device and, when said at least one obstacle is present, receiving distance data between said at least one detected obstacle and the vehicle,
determining whether the quality of visibility outside the vehicle is below a defined threshold,
determining whether predefined conditions representative of a hazard for the vehicle are met, the hazard originating from said at least one detected obstacle, said predefined conditions comprising at least the received distance data, and
when the predefined conditions representative of a hazard are met and when the visibility quality is below the defined threshold, displaying the captured images on an area of the display screen and superimposing, on these captured images and around said at least one detected obstacle, in real time, at least one synthesis image to signal said at least one detected obstacle.

2. The display method according to claim 1, further comprising, when the predefined conditions representative of a hazard are not met or when the visibility quality is equal to or greater than the defined threshold, displaying the images captured by the first imager on said area of the display screen.

3. The display method according to claim 1, wherein when the predefined conditions representative of a hazard are not met and when the visibility quality is less than said defined threshold, the method comprises a step of displaying the images captured by said first imager on said area of the display screen.

4. The display method according to claim 1, wherein the display system further comprises a second imager installed inside the vehicle and adapted to capture images representing the driver of the vehicle, and wherein the method further comprises the following steps:
capturing images via said second imager,
determining the position of the vehicle driver's gaze from images captured via the second imager, and
at least partially reducing a brightness of said area of the display screen when the determined gaze position is not directed toward said area of the display screen and when the predefined conditions representative of a hazard are not met.

5. The display method according to claim 1, further comprising a step of generating said at least one synthesis image comprising at least one signaling feature suitable for signaling the presence of the obstacle, the signaling feature being one of an arrow, an icon, a geometric figure, an overlay of said obstacle and an outline of said obstacle.

6. The display method according to claim 5, which further comprising a step of identifying said obstacle from the distance data, and wherein the generating step comprises generating a signaling feature representative of the identified obstacle.

7. The display method according to claim 1, wherein the step of determining whether predefined conditions have been met comprises the following steps:
calculating the distance between said obstacle and the vehicle from the distance data, and
comparing the calculated distance with a first defined distance value.

8. The display method according to claim 1, wherein the processing unit is adapted to receive at least one datum representative of the temperature outside the vehicle and at least one datum representative of the humidity outside the vehicle, and wherein the step of determining whether the predefined conditions have been met comprises the following steps:
calculating the distance between said obstacle and the vehicle from the distance data, receiving at least one temperature datum and/or at least one humidity datum,
comparing said temperature datum with at least one threshold temperature, and/or comparing said humidity datum with at least one threshold humidity, and
when said temperature datum is lower than said threshold temperature and/or when said humidity datum is lower than said threshold humidity, comparing said calculated distance with a second defined distance value.

9. The display method according to claim 1, wherein the step of determining whether predefined conditions have been met comprises the following steps:
calculating an amplitude and/or orientation of the speed of said obstacle, and
comparing the calculated amplitude with a defined amplitude and/or comparing the calculated orientation with a defined orientation range.

10. The display method according to claim 1, wherein the step of determining the quality of visibility outside the vehicle is carried out based on images captured by the first imager and/or distance data received.

11. The display method according to claim 1, wherein the at least one telemetry device comprises a radar, lidar or infrared light device.
